(19) United States
(12) Patent Application Publication
(10) Pub. No.: US 2014/0166827 A1
(43) Pub. Date: Jun. 19, 2014

(54) NOVELTY WINE BOTTLE HOLDER

(71) Applicant: Carolyn Berry, Dallas, TX (US)

(72) Inventor: Carolyn Berry, Dallas, TX (US)

(21) Appl. No.: 13/719,216

(22) Filed: Dec. 18, 2012

(51) Int. Cl. F16M 11/00

(52) U.S. Cl. CPC F16M 11/00
USPC 248/176.1

(57) ABSTRACT

The invention disclosed herein provides an apparatus, system and method for supporting a bottle of liquid on a flat surface at an angle so as to prevent that liquid from leaking out of the bottle. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### TECHNICAL FIELD OF THE INVENTION

The present invention relates to wine storage.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

After a wine bottle is opened, it is often stored in a refrigerator. However, when a wine bottle's cork is removed, the cork screw leaves a small hole in the cork. And, few refrigerators have shelves that are separated enough to store a wine-bottle upright. Unfortunately, if one lays the wine bottle on its side in a refrigerator (or other flat surface), wine leaks though the cork. Accordingly, there is the need for a device that enables one to lay a wine bottle on its side without leaking.

### BRIEF DESCRIPTION OF THE DRAWINGS

Various aspects of the invention, as well as an embodiment, are better understood by reference to the following detailed description. To better understand the invention, the detailed description should be read in conjunction with the drawings and tables, in which:

FIG. 1 illustrates an inventive wine bottle holder.

FIG. 2 is a head-on view of the wine bottle holder.

FIG. 3 illustrates a bottle of wine at rest in the wine bottle holder.

FIG. 4 shows a novelty embodiment of a wine bottle holder according to the teachings of the invention.

### DETAILED DESCRIPTION OF THE INVENTION

### Interpretation Considerations

When reading this section (which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

It should be noted in the following discussion that acts with like names are performed in like manners, unless otherwise stated. Of course, the foregoing discussions and definitions are provided for clarification purposes and are not limiting. Words and phrases are to be given their ordinary plain meaning unless indicated otherwise. The numerous innovative teachings of present application are described with particular reference to presently preferred embodiments.

### DESCRIPTION OF THE DRAWINGS

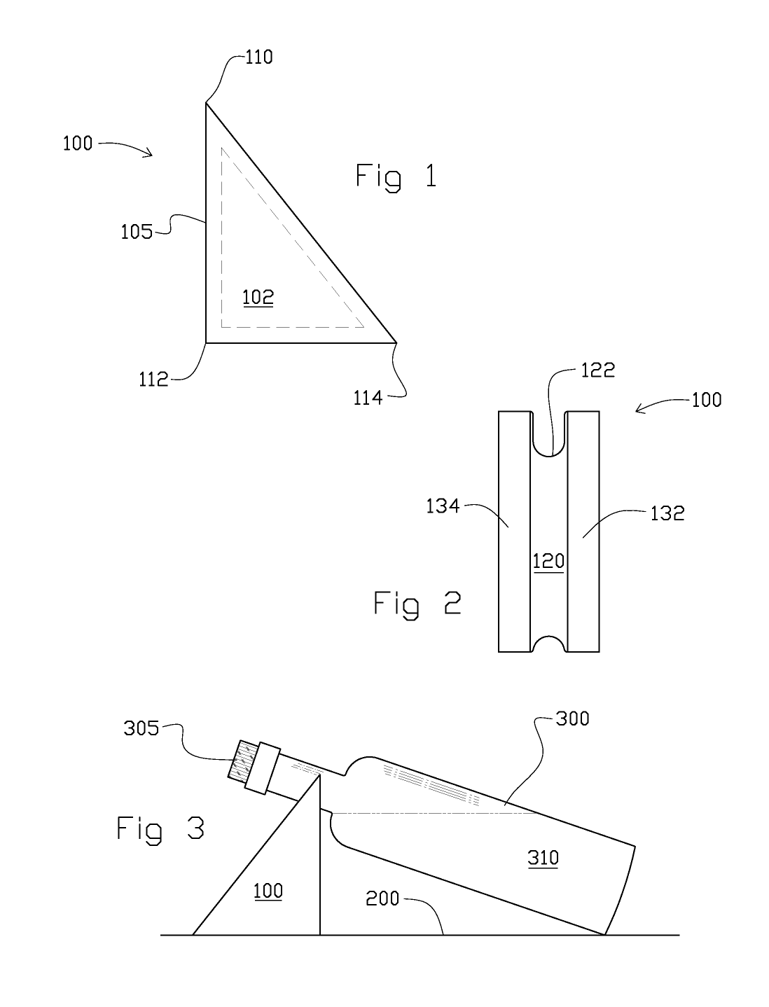

FIG. 1 illustrates an inventive wine bottle holder 100 (also, “holder”), having a body 102 which has channels and wedges that support a wine-bottle neck so that the cork of the wine-bottle is above the liquid level of wine in the bottle. The holder 100 is illustrated as a 30-60-90 triangle when viewed from the side shown in FIG. 1. The holder 100 has a vertical portion defined as a front surface 105, and has a top corner 110, a front corner 112 and a back corner, as well as bottom surface 107 and top surface 109. The front surface 105 being the longest surface, and being no more than 12-inches long, and preferably no more than 6-inches long.

FIG. 2 is a head-on view of the wine bottle holder front surface 105. From this view, it is seen that a front channel 120 traverses the length of the front surface 105. The front channel 120, a top channel 122, and a bottom channel 124, are shaped substantially like the neck of a wine bottle, preferably cylindrically (or technically a half-cylinder), and terminate with each other as illustrated. Each of the channels has approximately a ½ inch to two inch diameter width. Each of the front surface 105, bottom surface 107 and top surface 109 have a high-friction no-slip coating 132, such as a rubber epoxy, on at least a portion thereof. Although the holder 100 is substantially wedged-shaped as a 30-60-90 triangle, it is appreciated that many other shapes are available without departing from the scope of the invention. For example, an alternative holder could have a 20-70-90 angular dimensions. Similarly, in differing embodiments, a holder may have a rectangular, hexagonal or other polygonal shape. Additionally, advertisements may be placed on any flat surface of the holder 100.

FIG. 3 illustrates a bottle 300, such as a wine bottle, at rest in the wine bottle holder 100. Here, the wine bottle holder 100 sits on a flat surface 200, such as a refrigerator shelf, and the neck 302 of the bottle 300 is at rest in a notch created by the intersection of front channel 120, and the top channel 122 (not shown in FIG. 3). The bottle 300 is shown having a cork 305 which has been removed and partially re-inserted into the bottle 300. Within the bottle 300 is some liquid 310. From FIG. 3 it is seen that the slight elevation of the neck 302 prevents the cork 305 from coming into contact with the liquid 310, which prevents the liquid 310 from seeping through any holes in the cork 305.

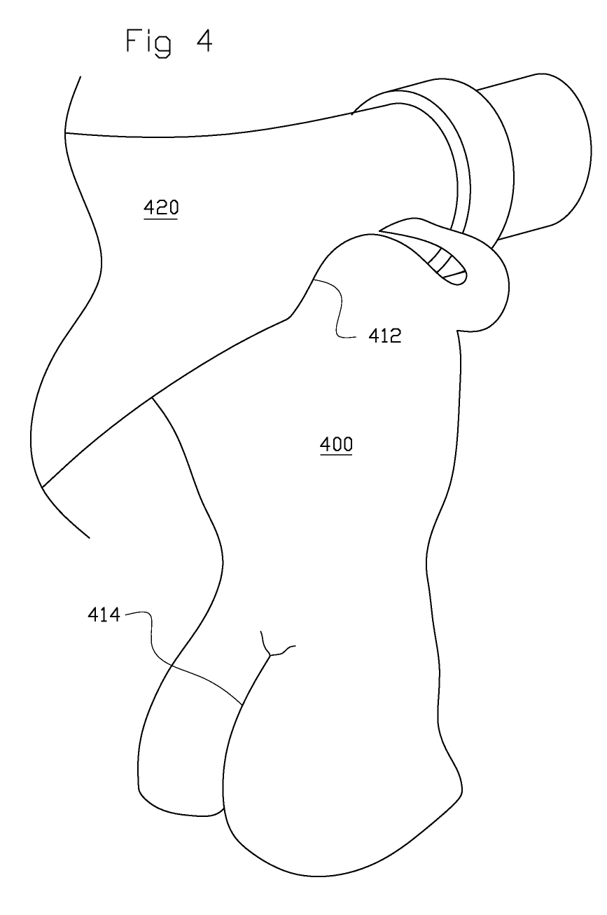

FIG. 4 shows a novelty embodiment of a wine bottle holder 400 according to the teachings of the invention. In the torso embodiment illustrated in FIG. 4, notches and channels are created by body contours. For example, the holder 400 has a notch created by a neck-line contour 412 which is supporting a bottle 420 in a raised position. Additionally, the holder 400 has a notch created by a derriere contour 414, which would support a neck of a bottle when the holder 400 is placed prone on a surface.

Though the invention has been described with respect to specific preferred embodiments, many variations and modifications will become apparent to those skilled in the art upon reading the present application. Specifically, the invention may be altered in ways readily apparent to those of ordinary skill in the art upon reading the present disclosure. It is therefore the intention that the appended claims and their equivalents be interpreted as broadly as possible in view of the prior art to include all such variations and modifications.

1. An apparatus for supporting a bottle at an angle, comprising:
a body having at least a front surface, a top surface and a bottom surface, the bottom surface having a substantially planar feature for resting on a flat surface, the bottom surface having a substantially half-cylindrical channel traversing the bottom surface; the channel being between ½ inch and two inches in diameter;
the top surface having a substantially planar feature for resting on a flat surface, the top surface having a substantially half-cylindrical channel traversing the top surface; the channel being between ½ and two inches in diameter;
the front surface having a substantially planar feature for resting on a flat surface, the front surface having a substantially half-cylindrical channel traversing the front surface; the channel being between ½ and two inches in diameter; and
the front surface, the bottom surface and the top surface meet to form a 30-60-90 triangle.

2. The apparatus of claim 1 further comprising a high-friction no-slip coating upon at least a portion of each of the top surface, bottom surface and front surface.

3. An apparatus for supporting a bottle at an angle, comprising:
a body having at least a front surface, a top surface and a bottom surface, the bottom surface having a substantially planar feature for resting on a flat surface;
the top surface having a contour that is shaped to accept a neck of a wine bottle;
the front surface being defined as the longest surface, and being no more than 12-inches in length; and
the bottom surface having a high-friction no-slip surface thereon.

4. The apparatus of claim 3 wherein the bottom surface has a substantially half-cylindrical channel traversing the bottom surface, the channel being between ½ inch and two inches in diameter.

5. An system for storing a wine bottle at an angle, comprising:
a body having at least a front surface, a top surface and a bottom surface, the bottom surface having a substantially planar feature that rest on a flat surface;
the top surface having a contour that is shaped to accept a neck of a bottle for storing liquid;
the front surface being defined as the longest surface, and being no more than 12-inches in length;
the bottom surface having a high-friction no-slip surface thereon; and
a bottle for storing liquid having a neck, the neck resting in the contour such that the bottle is at rest at an angle relative to the flat surface.

6. The system of claim 5 wherein the flat surface is a shelf of a refrigerator.
